(19) United States
(12) Patent Application Publication
(10) Pub. No.: US 2025/0070468 A1
(43) Pub. Date: Feb. 27, 2025

(54) Antenna System with Reconfigurable Circuits

(71) Applicant: MEDIATEK INC., HSIN-CHU (TW)

(72) Inventor: Chung-Hsin Chiang, Hsinchu City (TW)

(73) Assignee: MEDIATEK INC., HSIN-CHU (TW)

(21) Appl. No.: 18/806,650

(22) Filed: Aug. 15, 2024

Related U.S. Application Data
(60) Provisional application No. 63/578,196, filed on Aug. 23, 2023.

(51) Int. Cl. H01Q 5/335; H01Q 5/321; H01Q 9/28

(52) U.S. Cl. CPC H01Q 5/335; H01Q 5/321; H01Q 9/285

(57) ABSTRACT

An antenna system includes a first transformer, a first transceiver, a first switch, a second switch and an antenna. The first transformer includes a primary winding, and a secondary winding. The primary winding includes a first terminal and a second terminal, and the secondary winding includes a first terminal and a second terminal. The first transceiver is coupled to the first terminal of the primary winding of the first transformer. The first switch is coupled between the first terminal of the secondary winding of the first transformer and a ground. The second switch is coupled between the second terminal of the secondary winding of the first transformer and the ground. The antenna is coupled to the first terminal and the second terminal of the secondary winding of the first transformer. The antenna is a differential antenna.

### CROSS REFERENCE TO RELATED APPLICATIONS

This application claims the benefit of U.S. Provisional Application No. 63/578, 196, filed on Aug. 23, 2023. The content of the application is incorporated herein by reference.

### BACKGROUND

Antenna systems are fundamental components in wireless communication technologies, designed to facilitate the transmission and reception of electromagnetic signals. These systems consist of several elements: the antenna itself, a matching network, antenna control circuits and a transmission line. The primary function of an antenna system is convert to electrical signals into electromagnetic waves for transmission, and vice versa for reception. Additionally, it plays a crucial role in matching the impedance between the antenna and the transmitter or receiver to ensure efficient signal transfer.

There are various types of antenna systems, each suited for different applications and frequency ranges. Common types include simple dipoles, loop antennas, patch antennas, and phased arrays. When designing antenna systems, engineers must consider several key factors such as resonant frequency, bandwidth, gain, directivity, and impedance matching. These parameters significantly influence the performance and efficiency of the overall antenna system.

Antenna systems find applications in a wide range of technologies that rely on wireless communication. They are essential in radio and television broadcasting, mobile communications, satellite systems, radar technology, and short-range wireless devices like Wi-Fi routers and Bluetooth gadgets. As wireless technology continues to advance, the design and optimization of antenna systems remain critical areas of research and development in the field of telecommunications.

Antenna systems in 5G devices represent a significant leap forward in wireless communication technology, designed to meet the demanding requirements of fifth-generation networks. These systems are crucial for enabling the high-speed data transmission, low latency, and increased network capacity that 5G promises.

In 5G devices, antenna systems are characterized by their complexity and advanced design. They typically incorporate multiple antenna elements to support MIMO (Multiple-Input Multiple-Output) technology, which allows for simultaneous transmission and reception of multiple data streams. This approach significantly increases data throughput and improves spectral efficiency.

The miniaturization of antenna systems in 5G devices is intricately linked with complex antenna circuit design, reflecting the evolving demands of modern wireless technology. As 5G technology pushes the boundaries of performance, engineers are tasked with creating increasingly sophisticated antenna circuits that can operate efficiently within the confined spaces of compact mobile devices. These complex designs must address the challenges posed by higher frequency bands, including mmWave, which require more intricate signal processing and precise impedance matching. Advanced circuit techniques, such as adaptive matching networks and reconfigurable antenna elements, are being incorporated to optimize performance across multiple frequency bands and usage scenarios. The integration of active components directly into the antenna structure, forming active integrated antennas, further complicates the circuit design while offering improved efficiency and bandwidth. Moreover, the implementation of massive MIMO and beamforming technologies necessitates the development of complex feed networks and phase shifters within the antenna system.

To support the high data rates for modern cellular communication protocols such as 5G, the transmission wavelength is being expanded to the millimeter wave spectrum. Due to the smaller wavelength size at these higher frequencies, a mobile device may incorporate an array of antennas despite having a relatively small form factor. By utilizing different types of antennas within the array for communication coverage enhancements, the mobile device may change its beam direction and other t transmission parameters depending upon the RF environment. To drive the different antennas within an array, a mobile device may include separate transmitters that drive specific antennas through dedicated transmitter paths. However, the use of separate transmitters increases costs due to the increased semiconductor die space needed to form the various transmitters. To lower costs, a shared transmitter may be used to select between two or more antennas through an antenna switching network having switches in series with the shared transmitter and corresponding ones of the antennas. Although such shared transmitter architecture is feasible at lower frequencies, at the millimeter wave frequencies used for 5G, a significant amount of power will loss through the on-resistor and the off-capacitance in the switch transistor for a shared transmitter.

To address these challenges in modern antenna systems, particularly for 5G applications, researchers and engineers have developed several innovative approaches. One significant advancement is presented in U.S. Patent titled “TRANSFORMER-BASED ANTENNA SWITCHING NETWORK”, which discloses a transformer-based antenna switching network. This design incorporates a transformer with a secondary winding that extends between a first terminal and a second terminal. This configuration allows for selective coupling of transceivers and antennas, providing a more efficient and compact solution compared to traditional switching networks. The patent also describes variations of this basic design, including configurations with multiple transformers and antennas, offering flexibility for different array architectures.

Another innovative approach is detailed in a paper titled “Antenna Switch Embedded in Transmission Line Transformers of Differential PA and LNA,” published in the IEEE Microwave and Wireless Components Letters. This design embeds the antenna switch directly within the matching transmission line transformers (TLTs) of a differential power amplifier (PA) and low-noise amplifier (LNA). By integrating the switching function into the matching networks of the PA output and LNA input, this approach significantly reduces chip size and insertion loss. The design utilizes a three-port series-combining TLT with transmit and receive switches to simultaneously implement a balun, antenna switch, and matching networks for the PA and LNA. This integrated approach achieved notably low insertion losses and high isolation in both transmit and receive paths at 28 GHZ, demonstrating its potential for 5G millimeter-wave applications.

However, existing solutions frequently struggle to strike an optimal balance between performance, size, and manufacturability, highlighting the need for innovative approaches in this rapidly evolving field. There is still a need for intricate circuit designs to leverage cutting-edge semiconductor technologies and advanced packaging techniques to achieve the desired level of integration and performance in antenna systems.

### SUMMARY

An embodiment discloses an antenna system including a first transformer, a first transceiver, a first switch, a second switch and an antenna. The first transformer includes a primary winding, and a secondary winding. The primary winding includes a first terminal and a second terminal, and the secondary winding includes a first terminal and a second terminal. The first transceiver is coupled to the first terminal of the primary winding of the first transformer. The first switch is coupled between the first terminal of the secondary winding of the first transformer and a ground. The second switch is coupled between the second terminal of the secondary winding of the first transformer and the ground. The antenna is coupled to the first terminal and the second terminal of the secondary winding of the first transformer. The antenna is a differential antenna.

An embodiment discloses another antenna system including a first transformer, a first transmitter, a first receiver, a first switch, a second switch, a fifth switch, a sixth switch, and an antenna. The first transformer includes a primary winding, a secondary winding, and a tertiary winding, each includes a first terminal and a second terminal. The first transmitter is coupled to the first terminal of the primary winding of the first transformer. The first receiver is coupled to the first terminal of the secondary winding of the first transformer. The first switch is coupled between the first terminal of the tertiary winding of the first transformer and a ground. The second switch is coupled between the second terminal of the tertiary winding of the first transformer and the ground. The fifth switch is coupled between the first terminal and the second terminal of the primary winding of the first transformer. The sixth switch is coupled between the first terminal and the second terminal of the secondary winding of the first transformer. The antenna is coupled to the first terminal and the second terminal of the tertiary winding of the first transformer The antenna is a differential antenna.

An embodiment discloses another antenna system including a first transformer, a first transceiver, a second transceiver, a first switch, a second switch, a second transformer, a third transceiver, a fourth transceiver, a third switch, a fourth switch and an antenna. The first transformer includes a primary winding, a secondary winding, and a tertiary winding, each includes a first terminal and a second terminal. The first transceiver is coupled to the first terminal of the primary winding of the first transformer. The second transceiver is coupled to the first terminal of the secondary winding of the first transformer. The first switch is coupled between the first terminal of the tertiary winding of the first transformer and a ground. The second switch is coupled between the second terminal of the tertiary winding of the first transformer and the ground. The second transformer includes a primary winding, a secondary winding, and a tertiary winding, each includes a first terminal and a second terminal. The third transceiver is coupled to the first terminal of the primary winding of the second transformer. The fourth transceiver is coupled to the first terminal of the secondary winding of the second transformer. The third switch is coupled between the first terminal of the tertiary winding of the second transformer and the ground. The fourth switch is coupled between the second terminal of the tertiary winding of the second transformer and the ground. The antenna is coupled to the first terminal and the second terminal of the tertiary winding of the first transformer, and to the first terminal and the second terminal of the tertiary winding of the second transformer. The antenna is a differential antenna.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 illustrates an embodiment of the antenna system.

FIGS. 2 to 11 illustrate different embodiments or variations of the antenna system.

### DETAILED DESCRIPTION

The present disclosure provides a detailed description of various embodiments. While specific implementation details are presented herein to facilitate a comprehensive understanding of the disclosure, it will be apparent to those skilled in the art that the present invention may be realized without necessarily adhering to all such particularities. In certain instances, well-established methods, procedures, components, and circuits have been omitted from exhaustive description to avoid unnecessarily obfuscating the present disclosure. It should be understood that technical features individually described in relation to a single drawing may be implemented either discretely or in combination with other features, as set forth in the present specification.

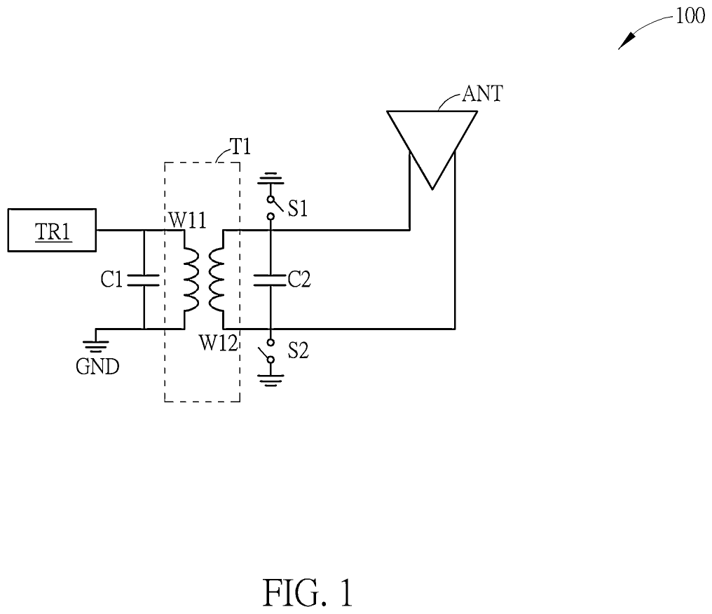

FIG. 1 illustrates an embodiment of an antenna system 100. The antenna system 100 includes a first transformer T1, a first transceiver TR1, a first switch S1, a second switch S2 and an antenna ANT. The first transformer T1 includes a primary winding W11 and a secondary winding W12. The primary winding W11 includes a first terminal and a second terminal, and the secondary winding W12 includes a first terminal and a second terminal. The first transceiver TR1 is coupled to the first terminal of the primary winding W11 of the first transformer T1. The first switch S1 is coupled between the first terminal of the secondary winding W12 of the first transformer T1 and the ground GND. The second switch S2 is coupled between the second terminal of the secondary winding W12 of the first transformer T1 and the ground GND. The antenna ANT is coupled to the first terminal and the second terminal of the secondary winding W12 of the first transformer T1. The antenna ANT is a differential antenna.

In an optional configuration of the antenna system 100, additional components may be incorporated for impedance matching purposes. Specifically, a first capacitor C1 may be electrically coupled between the first terminal and the second terminal of the primary winding W11 of the first transformer T1. Furthermore, a second capacitor C2 may be electrically coupled between the first terminal and the second terminal of the secondary winding W12 of the first transformer T1. These capacitors can be utilized to fine-tune the impedance characteristics of the system, potentially improving overall performance and efficiency.

The antenna ANT may be further characterized by a structural configuration with a first radiator and a second radiator. These radiators form a symmetrical configuration, thereby potentially enhancing the antenna's performance characteristics. Also, the first terminal of the secondary winding W12 of the first transformer T1 can be operatively coupled to the first radiator of the antenna ANT. Correspondingly, the second terminal of the secondary winding W12 of the first transformer T1 can be operatively coupled to the second radiator of the antenna ANT.

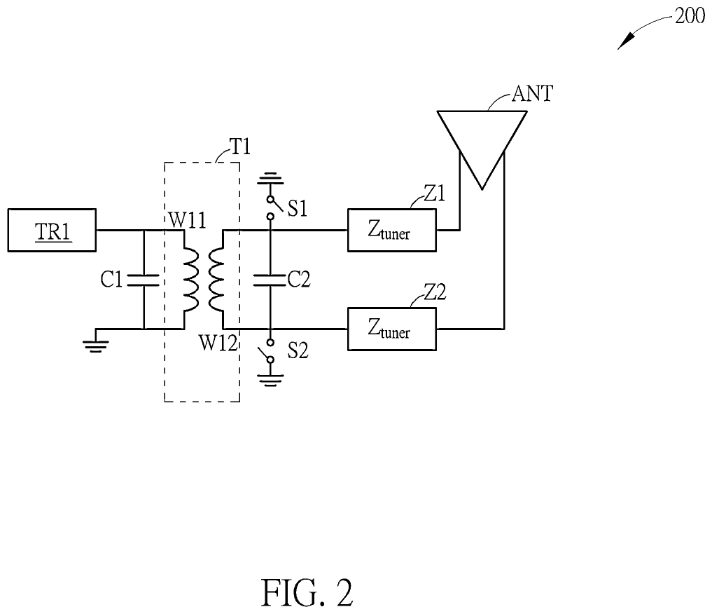

FIG. 2 illustrates an embodiment of an antenna system 200. This embodiment builds upon the configuration of antenna system 100, with the notable of addition impedance tuning elements. The distinguishing feature of the antenna system 200 is the incorporation of a first impedance tuner Z1 and a second impedance tuner Z2. Specifically, the first impedance tuner Z1 is operatively coupled between the first terminal of the secondary winding W12 of the first transformer T1 and the first radiator of the antenna ANT. In a complementary arrangement, the second impedance tuner Z2 is operatively coupled between the second terminal of the secondary winding W12 of the first transformer T1 and the second radiator of the antenna ANT.

These impedance tuners Z1 and 22 provide a means for dynamically adjusting the impedance characteristics of the antenna system 200. Such adjustability may allow for optimized impedance matching across various operating conditions, potentially enhancing power transfer efficiency, bandwidth, and overall system performance. The incorporation of these tuning elements exemplifies the adaptability and versatility of the present antenna system design.

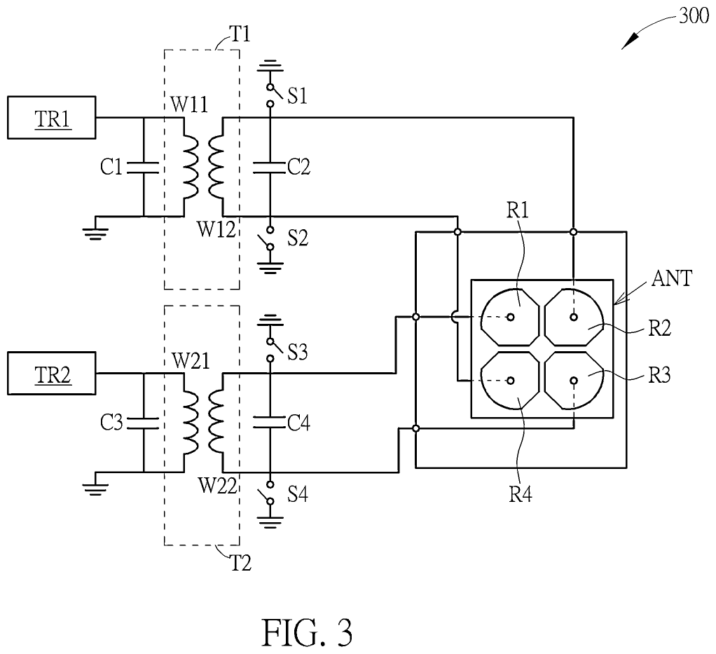

FIG. 3 illustrates an embodiment of an antenna system 300, which represents an enhanced configuration of the previously described antenna system 100. This embodiment incorporates additional components to further augment the capabilities and performance of the antenna system. The antenna system 300 includes a first transformer T1, a second transformer T2, a first transceiver TR1, a second transceiver TR2, a first switch S1, a second switch S2, a third switch S3, a fourth switch S4 and an antenna ANT.

The first transformer T1 includes a primary winding W11 and a secondary winding W12. The primary winding W11 includes a first terminal and a second terminal, and the secondary winding W12 includes a first terminal and a second terminal. The first transceiver TR1 is coupled to the first terminal of the primary winding W11 of the first transformer T1. The first switch S1 is coupled between the first terminal of the secondary winding W12 of the first transformer T1 and the ground GND. The second switch S2 is coupled between the second terminal of the secondary winding W12 of the first transformer T1 and the ground GND. The antenna ANT is coupled to the first terminal and the second terminal of the secondary winding W12 of the first transformer T1. The antenna ANT is a differential antenna.

The second transformer T2 includes a primary winding W21 and a secondary winding W22. Each of these windings includes a first terminal and a second terminal, providing multiple connection points for signal routing and manipulation. The second transceiver TR2 is operatively coupled to the first terminal of the primary winding W21 of the second transformer T2. This configuration allows for dual transceiver operation, potentially enabling simultaneous transmission and reception on different or same frequency bands or enhanced data throughput.

The third switch S3 is coupled between the first terminal of the secondary winding W22 of the second transformer T2 and the ground GND. Similarly, the fourth switch S4 is coupled between the second terminal of the secondary winding W22 of the second transformer T2 and the ground GND. These switches provide additional control over signal routing.

A key feature of this embodiment is that both the first terminal and the second terminal of the secondary winding W22 of the second transformer T2 are operatively coupled to the antenna ANT. This configuration allows for a more complex signal feed to the antenna, potentially enabling advanced beamforming or MIMO (Multiple Input Multiple Output) capabilities.

This enhanced configuration of antenna system 300 demonstrates the scalability and adaptability of the present invention, potentially offering improved performance and functionality in more demanding wireless communication applications.

In an optional configuration, the antenna system 300 may further incorporate additional capacitive elements to enhance impedance matching and overall system performance. These elements are strategically placed across the terminals of both transformers.

Specifically, a first capacitor C1 may be operatively coupled between the first terminal and the second terminal of the primary winding W11 of the first transformer T1. Correspondingly, a second capacitor C2 may be operatively coupled between the first terminal and the second terminal of the secondary winding W12 of the first transformer T1.

In a similar arrangement, a third capacitor C3 may be operatively coupled between the first terminal and the second terminal of the primary winding W21 of the second transformer T2. Likewise, a fourth capacitor C4 may be operatively coupled between the first terminal and the second terminal of the secondary winding W22 of the second transformer T2.

The inclusion of these capacitive elements provides a means for fine-tuning the impedance characteristics of each transformer independently. This configuration allows for optimized signal transfer and potentially improved bandwidth across both signal paths, further enhancing the versatility and efficiency of the antenna system 300.

The antenna ANT may be further characterized by a structural configuration with the radiators R1, R2, R3 and R4. These radiators form a symmetrical configuration, thereby potentially enhancing the antenna's performance characteristics. Also, the first terminal of the secondary winding W12 of the first transformer T1 can be operatively coupled to the radiator R2 of the antenna ANT; the second terminal of the secondary winding W12 of the first transformer T1 can be operatively coupled to the radiator R4 of the antenna ANT. Correspondingly the first terminal of the secondary winding W22 of the second transformer T2 can be operatively coupled to the radiator R1 of the antenna ANT, and the second terminal of the secondary winding W22 of the second transformer T2 can be operatively coupled to the radiator R3 of the antenna ANT.

This symmetrical arrangement of radiators R1, R2, R3, and R4 forms a balanced configuration. Such a design may contribute to improved signal balance, reduced polarization leakage, and enhanced radiation pattern symmetry. This configuration aligns with the differential nature of the antenna system, potentially offering benefits in signal integrity, spatial diversity, and overall system efficiency. The arrangement may be particularly advantageous for MIMO applications or for implementing advanced beamforming techniques.

The following table shows the radiation direction of the radiators R1-R4 in relation to the operation of the switches S1-S4 in the antenna system 300:

| Beam | [symbol] | [symbol] | [symbol] | [symbol] | ↑ | ↓ | ← | → | ⊙ | ⊙ | ⊙ |
|---|---|---|---|---|---|---|---|---|---|---|---|
| Radiator | R1 | R2 | R3 | R4 | R1 | R3 | R1 | R2 | R1 | R2 | R1 R3 |
| | | | | | R2 | R4 | R4 | R3 | R3 | R4 | R2 R4 |
| S1 | short | open | short | short | open | short | short | open | short | open | open |
| S2 | short | short | short | open | short | open | open | short | short | open | open |
| S3 | open | short | short | short | open | short | open | short | open | short | open |
| S4 | short | short | open | short | short | open | short | open | open | short | open |
| Power | 1 | 1 | 1 | 1 | 2 | 2 | 2 | 2 | 1 | 1 | 2 |

The embodiment enables sophisticated control over the radiation pattern through selective switch operations. When the switch S3 is open and other switches (i.e., S1, S2 and S4) are shorted, the signal propagates through the first terminal of secondary winding W22, leading the radiator R1 to emit radiation patterns in up-left direction. Conversely, when the switch S1 is open and other switches are shorted, the signal propagates through the first terminal of W12, leading the radiator R2 to emit radiation patterns in up-right direction. With the switch S4 is open and other switches are shorted, the signal propagates through second terminal of the secondary winding W22, leading the radiator R3 to emit radiation patterns in down-right direction. When the switch S2 is open and other switches are shorted, the signal propagates through second terminal of the secondary winding W12, leading the radiator R4 to emit radiation patterns in down-left direction.

More complex operations are also possible. When the switches S1 and S3 are open and the switches S2 and S4 are shorted, the radiators R1 and R2 emit the radiation patterns in the upward direction. Reversing this configuration (the switches S1 and S3 being shorted, the switches S2 and S4 being open) causes radiators R3 and R4 to emit the radiation patterns in the downward direction. When the switches S2 and S3 are open and the switches S1 and S4 are shorted, the radiators R1 and R4 emit the radiation patterns in the leftward direction. Reversing this configuration (the switches S2 and S3 being shorted, the switches S1 and S4 being open) causes radiators R2 and R3 to emit the radiation patterns in the rightward direction. It should be noted that the radiation pattern produced by the simultaneous operation of two radiators exhibits approximately double the power output compared to the pattern generated by a single radiator.

Furthermore, when the switches S3 and S4 are both open and the switches S1 and S2 are both shorted, the radiators R1 and R3 emit radiation patterns in the outward direction with a first polarization direction. This outward emission is a result of the superposition of the dipole radiation patterns of R1 and R3. Similarly, when the switches S1 and S2 are open and the switches S3 and S4 are shorted, the radiators R2 and R4 emit radiation patterns in the outward direction with a second polarization direction which is orthogonal to the first polarization direction, again due to the superposition of the dipole radiation patterns. When the switches S1, S2, S3, and S4 are all open, the radiators R1 through R4 collectively generate an outward radiation pattern with two orthogonal polarization directions.

Furthermore, the power transmission is determined by the active transceivers and their operatively connections to specific radiators. Each transceiver, transceiver TR1 and transceiver TR2, can transmit 1 power unit independently. The overall power state of the antenna ANT depends on which transceivers are active: transceiver TR1 alone (1 unit), transceiver TR2 alone (1 unit), or both transceiver TR1 and transceiver TR2 simultaneously (2 units).

This versatile switching arrangement allows for dynamic control of the antenna's radiation pattern, direction polarization, and power combination, thereby enhancing the system's adaptability to various communication scenarios and environmental conditions.

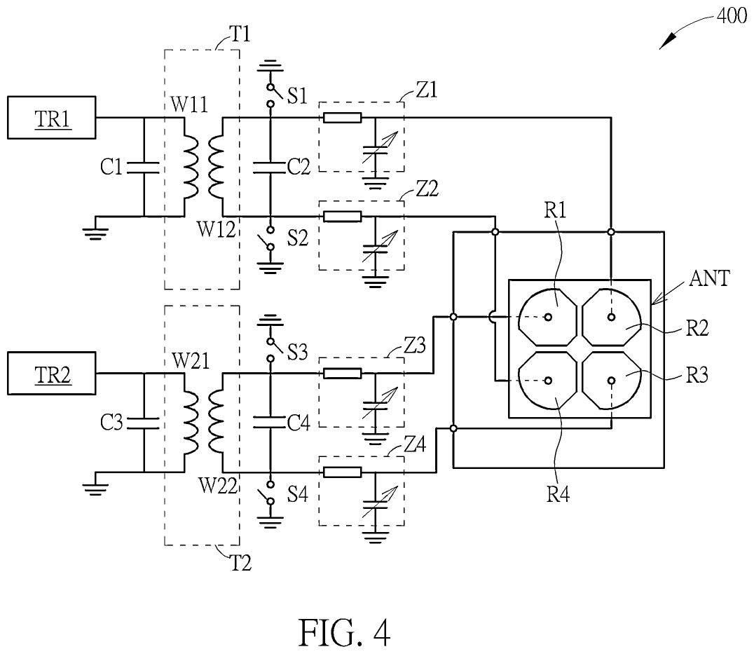

FIG. 4 illustrates an embodiment of an antenna system 400, which builds upon the configuration of antenna system 300 by introducing additional impedance tuning elements. The key distinction in this embodiment is the incorporation of four impedance tuners Z1, Z2, Z3, and Z4. These tuners are strategically positioned within the system to enhance its performance and adaptability. Specifically, the impedance tuner Z1 is operatively coupled between the first terminal of the secondary winding W12 and the second radiator R2, while the impedance tuner Z2 is coupled between the second terminal of the secondary winding W12 and the fourth radiator R4. Similarly, the impedance tuner Z3 is coupled between the first terminal of the secondary winding W22 and the first radiator R1, and the impedance tuner Z4 is coupled between the second terminal of the secondary winding W22 and the third radiator R3.

These impedance tuners Z1-24 can be realized using one or more phase shifters and varactors, allowing for dynamic impedance adjustment. This configuration potentially optimizes the system's performance across various operating conditions and frequencies. The inclusion of these tuning elements exemplifies the innovative approach of the present invention in addressing the challenges of modern antenna design and operation, offering enhanced flexibility and potentially improved performance in complex wireless communication scenarios.

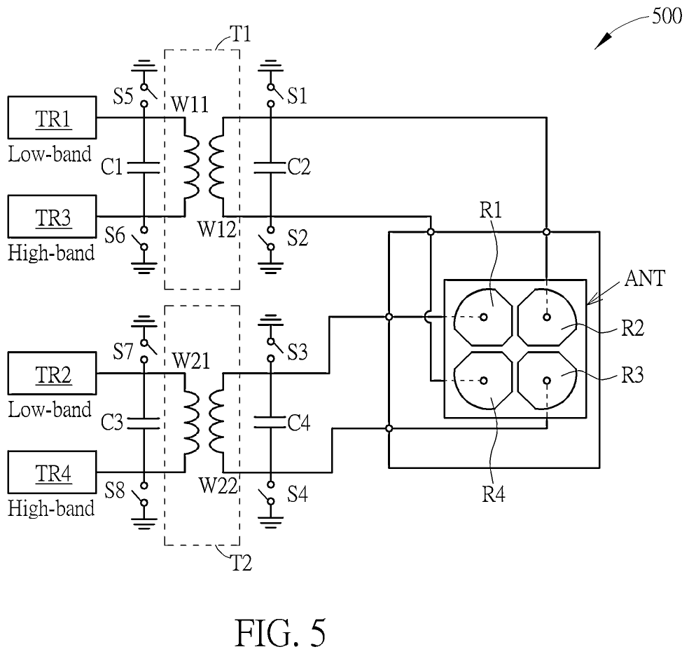

FIG. 5 illustrates an embodiment of an antenna system 500, which builds upon the configuration of antenna system 300 by introducing a third transceiver TR3 and a fourth transceiver TR4 with switches S5, S6, S7 and S8.

The third transceiver TR3 can be coupled to the second terminal of the primary winding W11 of the first transformer T1. The fourth transceiver TR4 can be coupled to the second terminal of the primary winding W21 of the second transformer T2. The switch S5 can be coupled between the first terminal of the primary winding W11 of the first transformer T1 and the ground GND. The switch S6 can be coupled between the second terminal of the primary winding W11 of the first transformer T1 and the ground GND. The switch S7 can be coupled between the first terminal of the primary winding W21 of the second transformer T2 and the ground GND. The switch S8 can be coupled between the second terminal of the primary winding W21 of the second transformer T2 and the ground GND.

In this embodiment, the antenna system 500 demonstrates a sophisticated multi-band operational capability through its strategic transceiver configurations. The first transceiver TR1 and the third transceiver TR3 are designed to function in different frequency bands. As an illustrative example, the first transceiver TR1 may be configured to operate in a lower frequency band (e.g., 28 GHZ), while the third transceiver TR3 is set to operate in a higher frequency band (e.g., 39 GHZ).

This dual-band arrangement is mirrored in the second pair of transceivers, where the second transceiver TR2 and the fourth transceiver TR4 also operate in different frequency bands. Consistent with the previous example, the second transceiver TR2 could be configured for the lower frequency band of 28 GHZ, while the fourth transceiver TR4 operates in the higher 39 GHz band.

This configuration enables the antenna system to simultaneously handle multiple frequency bands across both transformer circuits, enhancing its versatility and applicability across various wireless communication standards and requirements.

The antenna system 500 incorporates a switching control operation that builds upon the functionality of antenna system 300, with additional provisions for frequency band selection. This enhanced configuration allows for optimized performance across different frequency ranges. For operations in lower frequency bands, the system can be configured such that the switch S5 is open while the switch S6 is shorted, and/or the switch S7 is open while the switch S8 is shorted. This arrangement facilitates efficient signal propagation and radiation in the lower frequency spectrum. Conversely, when operating in higher frequency bands, the switch positions are reversed. The switch S5 can be shorted while the switch S6 is open, and/or the switch S7 can be shorted while the switch S8 is open. This configuration enables the antenna system 500 to effectively handle and radiate signals in different frequency bands. This feature potentially improves the system's overall performance and efficiency across a broader range of wireless communication applications.

The remainder of the switching control operation for antenna system 500 is identical to that of antenna system 300. For the sake of brevity, these details will not be repeated herein.

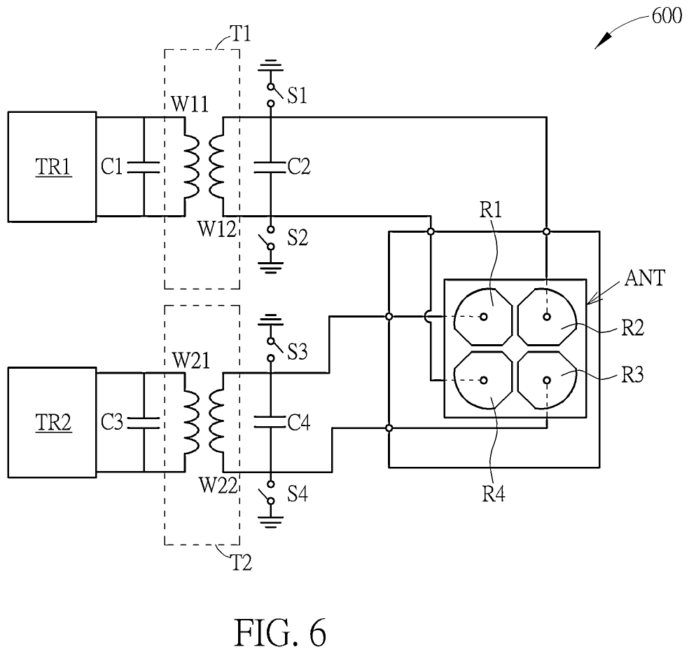

FIG. 6 illustrates an embodiment of an antenna system 600, which represents an alternative configuration of the previously described antenna system 300. The antenna system 600 includes a first transformer T1, a second transformer T2, a first transceiver TR1, a second transceiver TR2, a first switch S1, a second switch S2, a third switch S3, a fourth switch S4 and an antenna ANT.

The first transformer T1 includes a primary winding W11 and a secondary winding W12. The primary winding W11 includes a first terminal and a second terminal, and the secondary winding W12 includes a first terminal and a second terminal. The first transceiver TR1 is coupled to the first terminal and the second terminal of the primary winding W11 of the first transformer T1. The first switch S1 is coupled between the first terminal of the secondary winding W12 of the first transformer T1 and the ground GND. The second switch S2 is coupled between the second terminal of the secondary winding W12 of the first transformer T1 and the ground GND. The antenna ANT is coupled to the first terminal and the second terminal of the secondary winding W12 of the first transformer T1. The antenna ANT is a differential antenna.

Similarly, the second transformer T2 includes a primary winding W21 and a secondary winding W22. Each of these windings includes a first terminal and a second terminal, providing multiple connection points for signal routing and manipulation. The second transceiver TR2 is coupled to the first terminal and the second terminal of the primary winding W21 of the second transformer T2. This configuration allows for dual transceiver operation, potentially enabling simultaneous transmission and reception on different frequency bands or enhanced data throughput.

The third switch S3 is coupled between the first terminal of the secondary winding W22 of the second transformer T2 and the ground GND. Similarly, the fourth switch S4 is coupled between the second terminal of the secondary winding W22 of the second transformer T2 and the ground GND. These switches provide additional control over signal routing.

A key feature of this embodiment is that both the first terminal and the second terminal of the secondary winding W22 of the second transformer T2 are operatively coupled to the antenna ANT. This configuration allows for a more complex signal feed to the antenna, potentially enabling advanced beamforming or MIMO (Multiple Input Multiple Output) capabilities.

This enhanced configuration of antenna system 600 demonstrates the scalability and adaptability of the present invention, potentially offering improved performance and functionality in more demanding wireless communication applications.

In an optional configuration, the antenna system 600 may further incorporate additional capacitive elements to enhance impedance matching and overall system performance. These elements are strategically placed across the terminals of both transformers.

Specifically, a capacitor C1 may be operatively coupled between the first terminal and the second terminal of the primary winding W11 of the first transformer T1. Correspondingly, a capacitor C2 may be operatively coupled between the first terminal and the second terminal of the secondary winding W12 of the first transformer T1.

In a similar arrangement, a capacitor C3 may be operatively coupled between the first terminal and the second terminal of the primary winding W21 of the second transformer T2. Likewise, a capacitor C4 may be operatively coupled between the first terminal and the second terminal of the secondary winding W22 of the second transformer T2.

The inclusion of these capacitive elements provides a means for fine-tuning the impedance characteristics of each transformer independently. This configuration allows for optimized signal transfer and potentially improved bandwidth across both signal paths, further enhancing the versatility and efficiency of the antenna system 600.

The antenna ANT may be further characterized by a structural configuration with the radiators R1, R2, R3 and R4. These radiators form a symmetrical configuration, thereby potentially enhancing the antenna's performance characteristics. Also, the first terminal of the secondary winding W12 of the first transformer T1 can be operatively coupled to the radiator R2 of the antenna ANT; the second terminal of the secondary winding W12 of the first transformer T1 can be operatively coupled to the radiator R4 of the antenna ANT. Correspondingly the first terminal of the secondary winding W22 of the second transformer T2 can be operatively coupled to the radiator R1 of the antenna ANT, and the second terminal of the secondary winding W22 of the second transformer T2 can be operatively coupled to the radiator R3 of the antenna ANT.

This symmetrical arrangement of radiators R1, R2, R3, and R4 forms a balanced configuration. Such a design may contribute to improved signal balance, reduced polarization leakage, and enhanced radiation pattern symmetry. This configuration aligns with the differential nature of the antenna system, potentially offering benefits in signal integrity, spatial diversity, and overall system efficiency. The arrangement may be particularly advantageous for MIMO applications or for implementing advanced beamforming techniques.

The following table shows the radiation direction of the radiators R1-R4 in relation to the operation of the switches S1-S4 in the antenna system 600:

| Beam | [symbol] | [symbol] | [symbol] | [symbol] | ↑ | ↓ | ← | → | ⊙ | ⊙ | ⊙ |
|---|---|---|---|---|---|---|---|---|---|---|---|
| Radiator | R1 | R2 | R3 | R4 | R1 | R3 | R1 | R2 | R1 | R2 | R1 R3 |
| | | | | | R2 | R4 | R4 | R3 | R3 | R4 | R2 R4 |
| S1 | short | open | short | short | open | short | short | open | short | open | open |
| S2 | short | short | short | open | short | open | open | short | short | open | open |
| S3 | open | short | short | short | open | short | open | short | open | short | open |
| S4 | short | short | open | short | short | open | short | open | open | short | open |
| Power | 1 | 1 | 1 | 1 | 2 | 2 | 2 | 2 | 1 | 1 | 2 |

The embodiment enables sophisticated control over the radiation pattern through selective switch operations. When the switch S3 is open and other switches (i.e., S1, S2 and S4) are shorted, the signal propagates through the first terminal of secondary winding W22, leading the radiator R1 to emit radiation patterns in up-left direction. Conversely, when the switch S1 is open and other switches are shorted, the signal propagates through the first terminal of W12, leading the radiator R2 to emit radiation patterns in up-right direction. With the switch S4 open and other switches are shorted, the signal propagates through second terminal of the secondary winding W22, leading the radiator R3 to emit radiation patterns in down-right direction. When the switch S2 is open and other switches are shorted, the signal propagates through second terminal of the secondary winding W12, leading the radiator R4 to emit radiation patterns in down-left direction.

More complex operations are also possible. When the switches S1 and S3 are open and the switches S2 and S4 are shorted, the radiators R1 and R2 emit the radiation patterns in the upward direction. Reversing this configuration (the switches S1 and S3 being shorted, the switches S2 and S4 being open) causes radiators R3 and R4 to emit the radiation patterns in the downward direction. When the switches S2 and S3 are open and the switches S1 and S4 are shorted, the radiators R1 and R4 emit the radiation patterns in the leftward direction. Reversing this configuration (the switches S2 and S3 being shorted, the switches S1 and S4 being open) causes radiators R2 and R3 to emit the radiation patterns in the rightward direction. It should be noted that the radiation pattern produced by the simultaneous operation of two radiators exhibits approximately double the power output compared to the pattern generated by a single radiator.

Furthermore, when the switches S3 and S4 are both open and the switches S1 and S2 are both shorted, the radiators R1 and R3 emit radiation patterns in the outward direction with a first polarization direction. This outward emission is a result of the superposition of the dipole radiation patterns of R1 and R3. Similarly, when switches S1 and S2 are open and the switches S3 and S4 are shorted, the radiators R2 and R4 emit radiation patterns in the outward direction with a second polarization direction which is orthogonal to the first polarization direction, again due to the superposition of the dipole radiation patterns. When switches S1, S2, S3, and S4 are all open, the radiators R1 through R4 collectively generate an outward radiation pattern with two orthogonal polarization directions.

In more detail, the power transmission is determined by the active transceivers and their operatively connections to specific radiators. Each transceiver, transceiver TR1 and transceiver TR2, can transmit 1 power unit independently. The overall power state of the antenna ANT depends on which transceivers are active (or more explicitly which transmitters in transceivers are active): transceiver TR1 alone (1 unit), transceiver TR2 alone (1 unit), or both transceiver TR1 and transceiver TR2 simultaneously (2 units). For instance, when only radiator R1 is active with transceiver TR1, the power output is 1 unit. When radiator R1 and radiator R2 are active, with transceiver TR1 operatively connected to radiator R2 and transceiver TR2 to radiator R1, the total power output is 2 units. In a differential input configuration, such as transceiver TR2 operatively connected to radiator R1 and radiator R3, the power remains 1 unit as only one transceiver is active. The maximum power of 2 units is achieved when both transceivers operate in differential mode, with transceiver TR1 operatively connected to radiator R2 and radiator R4, and transceiver TR2 to radiator R1 and radiator R3. This flexible configuration allows for varied power outputs and radiation patterns depending on the specific operational requirements.

This versatile switching arrangement allows for dynamic control of the antenna's radiation pattern, direction polarization, and power combination, thereby enhancing the system's adaptability to various communication scenarios and environmental conditions.

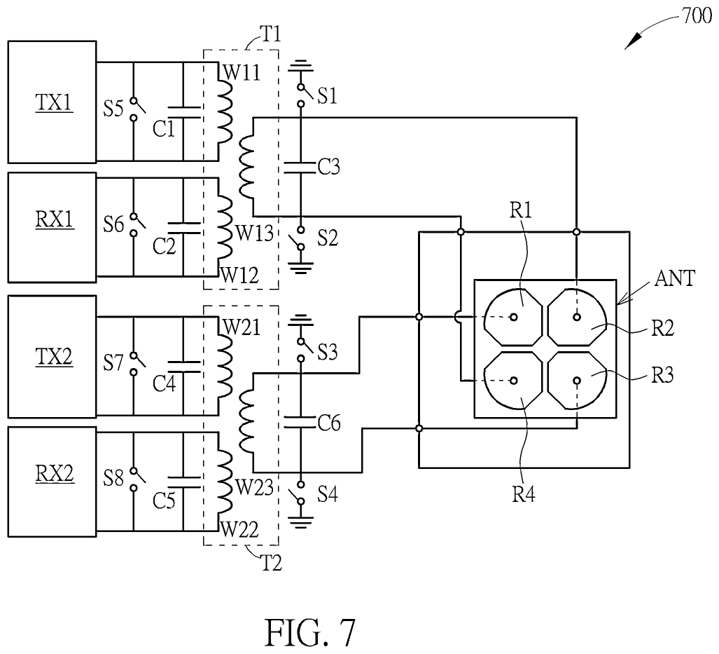

FIG. 7 illustrates an embodiment of an antenna system 700, which represents an alternative configuration of the previously described embodiments. The antenna system 700 introduces tertiary windings of the transformers. The addition of a third winding to each transformer expands the capabilities of the antenna system and potentially offers greater flexibility in signal routing and impedance matching.

The antenna system 700 includes a first transformer T1, a second transformer T2, a first transmitter TX1, a first receiver RX1, switches S1-S8, a second transformer T2, a second transmitter TX2, a second receiver RX2, and an antenna ANT. It should be noted that the transceiver in the previous embodiments are substituted by a transmitter and the receiver.

The first transformer T1 includes a primary winding W11, a secondary winding W12, and a tertiary winding W13, each includes a first terminal and a second terminal. The first transmitter TX1 is coupled to the first and second terminals of the primary winding W11 of the first transformer T1. The first receiver RX1 is coupled to the first and second terminals of the secondary winding W12 of the first transformer T1. The switch S1 is coupled between the first terminal of the tertiary winding W13 of the first transformer T1 and the ground GND. The switch S2 is coupled between the second terminal of the tertiary winding W13 of the first transformer T1 and the ground GND.

The second transformer T2 includes a primary winding W21, a secondary winding W22, and a tertiary winding W23, each includes a first terminal and a second terminal. The second transmitter TX2 is coupled to the first and second terminals of the primary winding W21 of the second transformer T2. The second receiver RX2 is coupled to the first and second terminals of the secondary winding W22 of the second transformer T2. The switch S3 is coupled between the first terminal of the tertiary winding W23 of the second transformer T2 and the ground GND. The switch S4 is coupled between the second terminal of the tertiary winding W23 of the second transformer T2 and the ground GND.

The switch S5 is coupled between the first terminal and the second terminal of the primary winding W11 of the first transformer T1. The switch S6 is coupled between the first terminal and the second terminal of the secondary winding W12 of the first transformer T1. The switch S7 is coupled between the first terminal and the second terminal of the primary winding W21 of the second transformer T2. The switch S8 is coupled between the first terminal and the second terminal of the secondary winding W22 of the second transformer T2.

The antenna ANT is coupled to the first terminal and the second terminal of the tertiary winding W13 of the first transformer T1, and to the first terminal and the second terminal of the tertiary winding W23 of the second transformer T2. The antenna ANT is a differential antenna.

The antenna system 700 may optionally incorporate additional capacitive elements to enhance its performance and tuning capabilities. Specifically, it may include six capacitors C1, C2, C3, C4, C5, and C6. The capacitor C1 can be coupled between the terminals of the primary winding W11 of the first transformer T1, while the capacitor C2 is similarly positioned across the secondary winding W12, and the capacitor C3 is coupled in parallel with the tertiary winding W13 of first transformer T1. In a parallel arrangement, the capacitor C4 is coupled across the primary winding W21 of the second transformer T2, the capacitor C5 is coupled across the secondary winding W22, and the capacitor C6 is placed between the terminals of the tertiary winding W23 of second transformer T2. These capacitors provide additional means for impedance matching and frequency tuning, potentially optimizing the performance across various operating conditions.

The antenna ANT may be further characterized by a structural configuration with the radiators R1, R2, R3 and R4. These radiators form a symmetrical configuration, thereby potentially enhancing the antenna's performance characteristics. Also, the first terminal of the tertiary winding W13 of the first transformer T1 can be operatively coupled to the radiator R2 of the antenna ANT; the second terminal of the tertiary winding W13 of the first transformer T1 can be operatively coupled to the radiator R4 of the antenna ANT. Correspondingly the first terminal of the tertiary winding W23 of the second transformer T2 can be operatively coupled to the radiator R1 of the antenna ANT, and the second terminal of the tertiary winding W23 of the second transformer T2 can be operatively coupled to the radiator R3 of the antenna ANT.

This symmetrical arrangement of radiators R1, R2, R3, and R4 forms a balanced configuration. Such a design may contribute to improved signal balance, reduced polarization leakage, and enhanced radiation pattern symmetry. This configuration aligns with the differential nature of the antenna system, potentially offering benefits in signal integrity, spatial diversity, and overall system efficiency. The arrangement may be particularly advantageous for MIMO applications or for implementing advanced beamforming techniques.

The following table shows the radiation direction of the radiators R1-R4 in relation to the operation of the switches S1-S4 in the antenna system 700:

| Beam | [symbol] | [symbol] | [symbol] | [symbol] | ↑ | ↓ | ← | → | ⊙ | ⊙ | ⊙ |
|---|---|---|---|---|---|---|---|---|---|---|---|
| Radiator | R1 | R2 | R3 | R4 | R1 | R3 | R1 | R2 | R1 | R2 | R1 R3 |
| | | | | | R2 | R4 | R4 | R3 | R3 | R4 | R2 R4 |
| S1 | short | open | short | short | open | short | short | open | short | open | open |
| S2 | short | short | short | open | short | open | open | short | short | open | open |
| S3 | open | short | short | short | open | short | open | short | open | short | open |
| S4 | short | short | open | short | short | open | short | open | open | short | open |
| Power | 1 | 1 | 1 | 1 | 2 | 2 | 2 | 2 | 1 | 1 | 2 |

The operational principles governing the switches S1-S4 and their influence on the radiation patterns of radiators R1-R4 in the antenna system 700 are consistent with those established for antenna system 600. For the sake of brevity and to avoid redundancy, these operational details will not be repeated in this description.

The switches S5 and S6 function as a selective pair for routing signals associated with either the first transmitter TX1 or the first receiver RX1. When the switch S5 is open and the switch S6 is shorted, the antenna system 700 is configured to transmit, allowing signals from the first transmitter TX1 to propagate through the system. Conversely, when the switch S5 is shorted and the switch S6 is open, the antenna system 700 is set to receive, directing incoming signals to the first receiver RX1. This switching mechanism enables the antenna system 700 to alternate between transmission and reception modes. The same operational principle applies to the switches S7 and S8, which control signal routing for the second transmitter TX2 and second receiver RX2, respectively. This configuration allows for independent control of transmission and reception paths in both transformer circuits, enhancing flexibility and functionality.

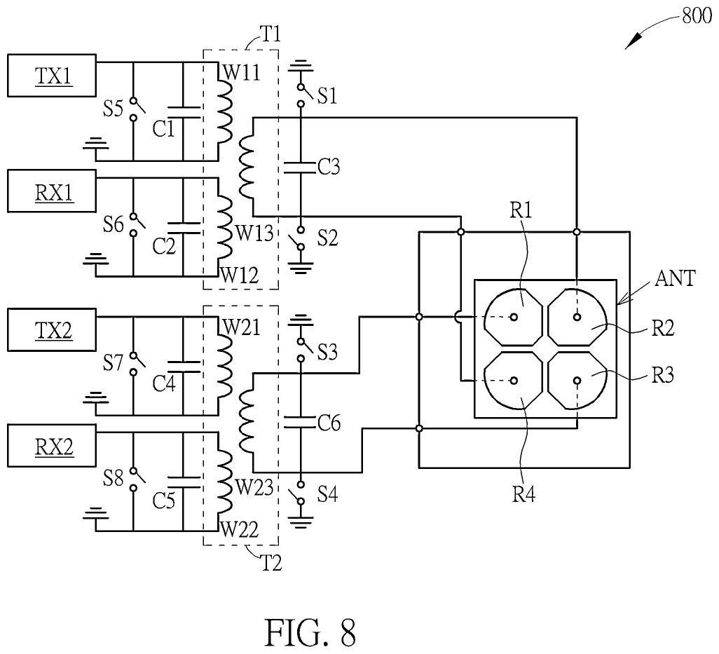

FIG. 8 illustrates an embodiment of antenna system 800, which represents an alternative configuration of the previously described antenna system 700. The key distinction in this configuration lies in the coupling arrangements of the transmitters and receivers. Specifically, the first transmitter TX1 is uniquely coupled to the first terminal of the primary winding W11 of the first transformer T1, while the first receiver RX1 is uniquely coupled to the first terminal of the secondary winding W12 of the first transformer T1. Similarly, the second transmitter TX2 is uniquely coupled to the first terminal of the primary winding W21 of the second transformer T2, and the second receiver RX2 is also uniquely coupled to the first terminal of the secondary winding W22 of the second transformer T2. The second terminals of the primary windings W11 and W21 and the secondary windings W12 and W22 are coupled to the ground GND.

The remainder of the circuit configuration maintains consistency with the previously detailed antenna system 700. This includes the arrangement of transformers, windings, additional switches, and other components not explicitly mentioned in the description of system 800.

The operational principles governing switches S1-S8 and their influence on the radiation patterns of radiators R1-R4 in the antenna system 800 are consistent with those established for antenna system 700. For the sake of brevity and to avoid redundancy, these operational details will not be repeated in this description.

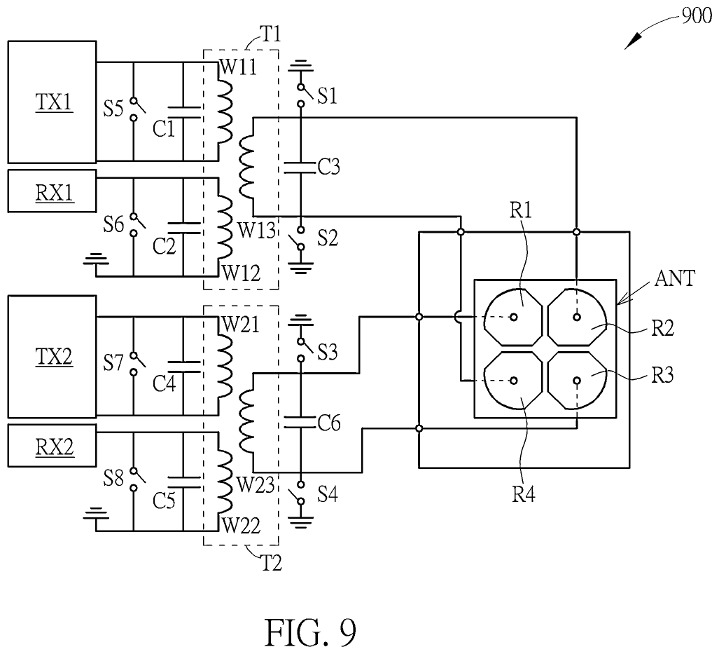

FIG. 9 illustrates an embodiment of antenna system 900, which represents an alternative configuration of the previously described antenna system 700. The key distinction in this configuration lies in the coupling arrangements of the transmitters and receivers. Specifically, the first transmitter TX1 is coupled to the first terminal and the second terminal of the primary winding W11 of the first transformer T1, while the first receiver RX1 is uniquely coupled to the first terminal of the secondary winding W12 of the first transformer T1. Similarly, the second transmitter TX2 is coupled to the first terminal and the second terminal of the primary winding W21 of the second transformer T2, and the second receiver RX2 is uniquely coupled to the first terminal of the secondary winding W22 of the second transformer T2. The second terminals of the secondary windings W21 and W22 are coupled to the ground GND.

The remainder of the circuit configuration maintains consistency with the previously detailed antenna system 700. This includes the arrangement of transformers, windings, additional switches, and other components not explicitly mentioned in the description of system 900.

The operational principles governing switches S1-S8 and their influence on the radiation patterns of radiators R1-R4 in the antenna system 900 are consistent with those established for antenna system 700. For the sake of brevity and to avoid redundancy, these operational details will not be repeated in this description.

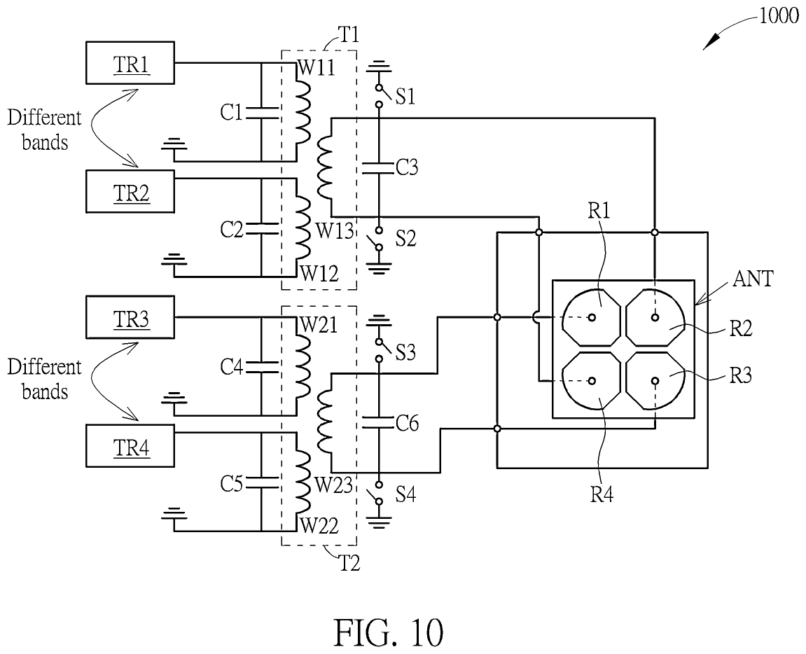

FIG. 10 illustrates an embodiment of an antenna system 1000, which represents an alternative configuration of the previously described embodiments. The antenna system 1000 includes a first transformer T1, a first transceiver TR1, a second transceiver TR2, a second transformer T2, a third transceiver TR3, a fourth transceiver TR4, switches S1-S4 and an antenna ANT.

The first transformer T1 includes a primary winding W11, a secondary winding W12, and a tertiary winding W13, each includes a first terminal and a second terminal. The first transceiver TR1 is coupled to the first terminal of the primary winding W11 of the first transformer T1. The second transceiver TR2 is coupled to the first terminal of the secondary winding W12 of the first transformer T1. The switch S1 is coupled between the first terminal of the tertiary winding W13 of the first transformer T1 and the ground GND. The switch S2 is coupled between the second terminal of the tertiary winding W13 of the first transformer T1 and the ground GND.

The second transformer T2 includes a primary winding W21, a secondary winding W22, and a tertiary winding W23, each includes a first terminal and a second terminal. The third transceiver TR3 is coupled to the first terminal of the primary winding W21 of the second transformer T2. The fourth transceiver TR4 is coupled to the first terminal of the secondary winding W22 of the second transformer T2. The switch S3 is coupled between the first terminal of the tertiary winding W23 of the second transformer T2 and the ground GND. The switch S4 is coupled between the second terminal of the tertiary winding W23 of the second transformer T2 and the ground GND.

The antenna ANT may be further characterized by a structural configuration with the radiators R1, R2, R3 and R4. These radiators form a symmetrical configuration, thereby potentially enhancing the antenna's performance characteristics. Also, the first terminal of the tertiary winding W13 of the first transformer T1 can be operatively coupled to the radiator R2 of the antenna ANT; the second terminal of the tertiary winding W13 of the first transformer T1 can be operatively coupled to the radiator R4 of the antenna ANT. Correspondingly the first terminal of the tertiary winding W23 of the second transformer T2 can be operatively coupled to the radiator R1 of the antenna ANT, and the second terminal of the tertiary winding W23 of the second transformer T2 can be operatively coupled to the radiator R3 of the antenna ANT.

This symmetrical arrangement of radiators R1, R2, R3, and R4 forms a balanced configuration. Such a design may contribute to improved signal balance, reduced polarization leakage, and enhanced radiation pattern symmetry. This configuration aligns with the differential nature of the antenna system, potentially offering benefits in signal integrity, spatial diversity, and overall system efficiency. The arrangement may be particularly advantageous for MIMO applications or for implementing advanced beamforming techniques.

The antenna system 1000 may optionally incorporate additional capacitive elements to enhance its performance and tuning capabilities. Specifically, it may include six capacitors C1, C2, C3, C4, C5, and C6. The capacitor C1 can be coupled between the terminals of the primary winding W11 of the first transformer T1, while the capacitor C2 is similarly positioned across the secondary winding W12 of the first transformer T1, and the capacitor C3 is coupled in parallel the tertiary winding W13 of first transformer T1. In a parallel arrangement, the capacitor C4 is coupled across the primary winding W21 of the second transformer T2, the capacitor C5 is coupled across the secondary winding W22 of the second transformer T2, and the capacitor C6 is placed between the terminals of the tertiary winding W23 of second transformer T2. These capacitors provide additional means for impedance matching and frequency tuning, potentially optimizing the performance across various operating conditions.

In this embodiment, the antenna system demonstrates a multi-band operational capability through its transceiver configurations. The first transceiver TR1 and the second transceiver TR2 are designed to function in distinct frequency bands. As an illustrative example, the first transceiver TR1 may be configured to operate in a lower frequency band (e.g., 28 GHZ) while the second transceiver TR2 is set to operate in a higher frequency band (e.g., 39 GHz).

This dual-band arrangement is mirrored in the second transformer circuit, where the third transceiver TR3 and the fourth transceiver TR4 also operate in different frequency bands. Consistent with the previous example, the third transceiver TR3 can be configured for the lower frequency band of 28 GHZ, while the fourth transceiver TR4 operates in the higher 39 GHz band.

This configuration enables the antenna system to simultaneously handle multiple frequency bands, enhancing its versatility and applicability across various wireless communication standards and requirements.

The antenna system 1000 operates on principles consistent with those described in the previous embodiment. For the sake of brevity and to avoid redundancy, the operational details will not be repeated in this description.

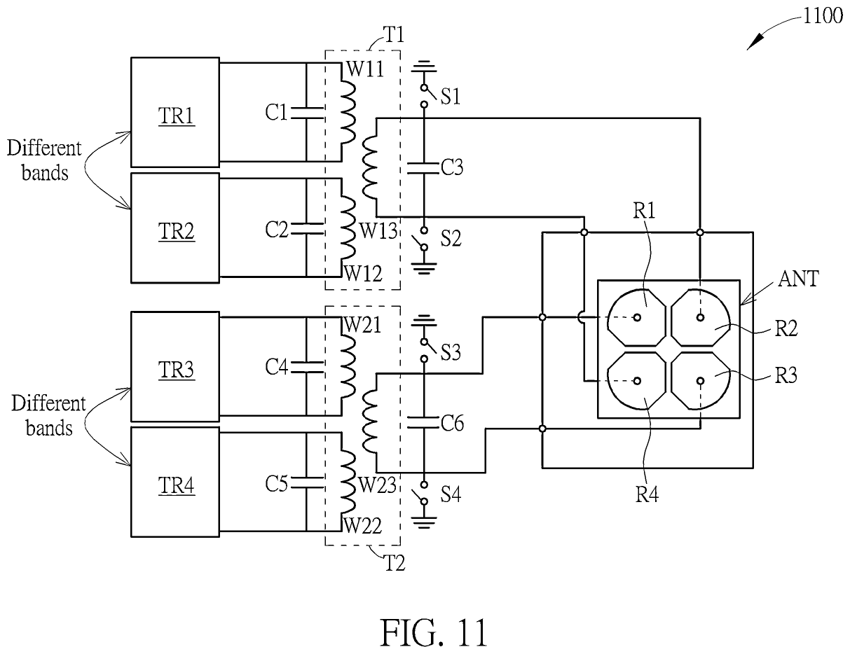

FIG. 11 illustrates an embodiment of an antenna system 1100, which represents an alternative configuration of the previously described antenna system 1000. The key distinctions lie in the connection of the transceivers. In this configuration, the second terminal of the primary winding W11 of the first transformer T1 is coupled to the first transceiver TR1, while the second terminal of its secondary winding W12 is coupled to the second transceiver TR2. Similarly, for the second transformer T2, the second terminal of the primary winding W21 is coupled to the third transceiver TR3, and the second terminal of its secondary winding W22 is coupled to the fourth transceiver TR4. These alterations in the coupling arrangement represent the primary difference between antenna systems 1100 and 1000, offering different operational characteristics or performance advantages. The remainder of the architecture and components of the antenna system are consistent with the antenna system 1000. Hence, the operation principle also remains the same as that of the antenna system 1000.

The antenna systems with reconfigurable circuits described in these embodiments offer a range of significant advantages that make them particularly suitable for advanced wireless communication applications. At their core, these systems provide multi-band operation capabilities, allowing them to function across various frequency bands. This versatility is crucial in accommodating different wireless communication standards and applications within a single hardware setup.

The reconfigurable nature of these circuits, enabled by various switches and tuning elements, allows for adaptive performance. The systems can dynamically adjust to different operational requirements or environmental conditions, potentially improving efficiency and signal quality across various scenarios. This adaptability extends to flexible operation modes, allowing the systems to switch between transmission and reception as needed, and even enables advanced techniques like beamforming for improved signal directionality and strength.

From a design perspective, these systems offer several practical benefits. Their compact design, achieved through the use of transformers and switchable components, allows for efficient use of space compared to having separate antennas for each frequency band or operational mode. This approach can also lead to cost-effectiveness by reducing the need for multiple fixed antennas. Furthermore, the scalability of these designs means they can potentially incorporate additional frequency bands or operational modes as needed, making them more future-proof in the face of evolving wireless standards and requirements.

The terminology employed in the description of the various embodiments herein is intended for the purpose of describing particular embodiments and should not be construed as limiting. In the context of this description and the appended claims, the singular forms “a”, “an”, and “the” are intended to encompass plural forms as well, unless the context clearly indicates otherwise.

It should be understood that the term “and/or” as used herein is intended to encompass any and all possible combinations of one or more of the associated listed items. Furthermore, it should be noted that the terms “includes,” “including,” “comprises,” and/or “comprising,” when used in this specification, indicate the presence of stated features, integers, steps, operations, elements, and/or components, but do not exclude the presence or addition of one or more other features, integers, steps, operations, elements, components, and/or groups thereof.

In the context of this disclosure, the terms “coupled,” “connected,” “connecting,” “electrically connected,” and similar expressions are used interchangeably to broadly denote the state of being electrically or electronically connected. Furthermore, an entity is deemed to be in “communication” with another entity (or entities) when it electrically transmits and/or receives information signals to/from the other entity, irrespective of whether these signals contain image/voice information or data/control information, and regardless of the signal type (analog or digital). It is important to note that this communication can occur through either wired or wireless means. The use of these terms is intended to encompass all forms of electrical or electronic connectivity relevant to the described embodiments.

The directional terms used in the embodiments such as up, down, left, right, upper-side, down-side, in front of or behind are just the directions referring to the attached figures. Thus, the direction terms used in the present disclosure are for illustration, and are not intended to limit the scope of the present disclosure. It should be noted that the elements which are specifically described or labeled may exist in various forms for those skilled in the art.

The use of ordinal designators like “first,” “second,” and so forth in the specification and claims serves to differentiate between multiple instances of similarly named elements. These designators do not imply any inherent sequence, priority, or chronological order in the manufacturing process or functional relationship between elements. Rather, they are employed solely as a means of uniquely identifying and distinguishing between separate instances of elements that share a common name or description.

This interpretation of terminology is provided to ensure clarity and consistency throughout the specification and claims, and should not be construed as restricting the scope of the disclosed embodiments or the appended claims.

The various illustrative components, logic, logical blocks, modules, circuits, operations and algorithm processes described in connection with the embodiments disclosed herein may be implemented as electronic hardware, firmware, software, or combinations of hardware, firmware or software, including the structures disclosed in this specification and the structural equivalents thereof. The interchangeability of hardware, firmware and software has been described generally, in terms of functionality, and illustrated in the various illustrative components, blocks, modules, circuits and processes described above. Whether such functionality is implemented in hardware, firmware or software depends upon the particular application and design constraints imposed on the overall system.

The hardware and data processing apparatus utilized to implement the various illustrative components, logics, logical blocks, modules, and circuits described herein may comprise, without limitation, one or more of the following: a general-purpose single-chip or multi-chip processor, a digital signal processor (DSP), an application specific integrated circuit (ASIC), a field programmable gate array (FPGA), other programmable logic devices (PLDs), discrete gate or transistor logic, discrete hardware components, or any suitable combination thereof. Such hardware and apparatus shall be configured to perform the functions described herein.

A general-purpose processor may include, but is not limited to, a microprocessor, or alternatively, any conventional processor, controller, microcontroller, or state machine. In certain implementations, a processor may be realized as a combination of computing devices. Such combinations may include, for example, a DSP and a microprocessor, a plurality of microprocessors, one or more microprocessors in conjunction with a DSP core, or any other such configuration as may be suitable for the intended application.

It is to be understood that in some embodiments, particular processes, operations, or methods may be executed by circuitry specifically designed for a given function. Such function-specific circuitry may be optimized to enhance performance, efficiency, or other relevant metrics for the particular task at hand. The selection of specific hardware implementation shall be determined based on the particular requirements of the application, which may include, inter alia, performance specifications, power consumption constraints, cost considerations, and size limitations.

In certain aspects, the subject matter described herein may be implemented as software. Specifically, various functions of the disclosed components, or steps of the methods, operations, processes, or algorithms described herein, may be realized as one or more modules within one or more computer programs. These computer programs may comprise non-transitory processor-executable or computer-executable instructions, encoded on one or more tangible processor-readable or computer-readable storage media. Such instructions are configured for execution by, or to control the operation of, data processing apparatus, including the components of the devices described herein. The aforementioned storage media may include, but are not limited to, RAM, ROM, EEPROM, CD-ROM or other optical disk storage, magnetic disk storage or other magnetic storage devices, or any other medium capable of storing program code in the form of instructions or data structures. It should be understood that combinations of the above-mentioned storage media are also contemplated within the scope of computer-readable storage media for the purposes of this disclosure.

Various modifications to the embodiments described in this disclosure may be readily apparent to persons having ordinary skill in the art, and the generic principles defined herein may be applied to other embodiments without departing from the spirit or scope of this disclosure. Thus, the claims are not intended to be limited to the embodiments shown herein, but are to be accorded the widest scope consistent with this disclosure, the principles and the novel features disclosed herein.

In certain implementations, the embodiments may comprise the disclosed features and may optionally include additional features not explicitly herein. described Conversely, alternative implementations may be characterized by the substantial or complete absence of non-disclosed elements. For the avoidance of doubt, it should be understood that in some embodiments, non-disclosed elements may be intentionally omitted, either partially or entirely, without departing from the scope of the invention. Such omissions of non-disclosed elements shall not be construed as limiting the breadth of the claimed subject matter, provided that the explicitly disclosed features are present in the embodiment.

Additionally, various features that are described in this specification in the context of separate embodiments also can be implemented in combination in a single implementation. Conversely, various features that are described in the context of a single implementation also can be implemented in multiple embodiments separately or in any suitable subcombination. As such, although features may be described above as acting in particular combinations, and even initially claimed as such, one or more features from a claimed combination can in some cases be excised from the combination, and the claimed combination may be directed to a subcombination or variation of a subcombination.

The depiction of operations in a particular sequence in the drawings should not be construed as a requirement for strict adherence to that order in practice, nor should it imply that all illustrated operations must be performed to achieve the desired results. The schematic flow diagrams may represent example processes, but it should be understood that additional, unillustrated operations may be incorporated at various points within the depicted sequence. Such additional operations may occur before, after, simultaneously with, or between any of the illustrated operations.

Additionally, it should be understood that the various figures and component diagrams presented and discussed within this document are provided for illustrative purposes only and are not drawn to scale. These visual are intended representations to facilitate understanding of the described embodiments and should not be construed as precise technical drawings or limiting the scope of the invention to the specific arrangements depicted.

In certain implementations, multitasking and parallel processing may prove advantageous. Furthermore, while various system components are described as separate entities in some embodiments, this separation should not be interpreted as mandatory for all embodiments. It is contemplated that the described program components and systems may be integrated into a single software package or distributed across multiple software packages, as dictated by the specific implementation requirements.

It should be noted that other embodiments, beyond those explicitly described, fall within the scope of the appended claims. The actions specified in the claims may, in some instances, be performed in an order different from that in which they are presented, while still achieving the desired outcomes. This flexibility in execution order is an inherent aspect of the claimed processes and should be considered within the scope of the invention.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. An antenna system comprising:
a first transformer, comprising:
a primary winding, comprising a first terminal and a second terminal; and
a secondary winding, comprising a first terminal and a second terminal;
a first transceiver coupled to the first terminal of the primary winding of the first transformer;
a first switch coupled between the first terminal of the secondary winding of the first transformer and a ground;
a second switch coupled between the second terminal of the secondary winding of the first transformer and the ground; and
an antenna coupled to the first terminal and the second terminal of the secondary winding of the first transformer;
wherein the antenna is a differential antenna.

2. The antenna system of claim 1, further comprising:
a first capacitor coupled between the first terminal and the second terminal of the primary winding of the first transformer; and
a second capacitor coupled between the first terminal and the second terminal of the secondary winding of the first transformer.

3. The antenna system of claim 1, wherein the antenna comprises a first radiator and a second radiator, and the first radiator and the second radiator form a symmetrical configuration.

4. The antenna system of claim 3, wherein the first terminal of the secondary winding of the first transformer is coupled to the first radiator, and the second terminal of the secondary winding of the first transformer is coupled to the second radiator.

5. The antenna system of claim 4, further comprising:
a first impedance tuner coupled between the first terminal of the secondary winding of the first transformer and the first radiator; and
a second impedance tuner coupled between the second terminal of the secondary winding of the first transformer and the second radiator.

6. The antenna system of claim 3, further comprising:
a second transformer, comprising:
a primary winding, comprising a first terminal and a second terminal; and
a secondary winding, comprising a first terminal and a second terminal;
a second transceiver coupled to the first terminal of the primary winding of the second transformer;
a third switch coupled between the first terminal of the secondary winding of the second transformer and the ground;
a fourth switch coupled between the second terminal of the secondary winding of the second transformer and the ground; and
wherein the first terminal and the second terminal of the secondary winding of the second transformer are coupled to the antenna.

7. The antenna system of claim 6, further comprising:
a third capacitor coupled between the first terminal and the second terminal of the primary winding of the second transformer; and
a fourth capacitor coupled between the first terminal and the second terminal of the secondary winding of the second transformer.

8. The antenna system of claim 6, wherein the antenna further comprises a third radiator and a fourth radiator, and the third radiator and the fourth radiator form a symmetrical configuration.

9. The antenna system of claim 8, wherein:
the first terminal of the secondary winding of the first transformer is coupled to the second radiator;
the second terminal of the secondary winding of the first transformer is coupled to the fourth radiator;
the first terminal of the secondary winding of the second transformer is coupled to the first radiator;
the second terminal of the secondary winding of the second transformer is coupled to the third radiator; and
the first radiator, the second radiator, the third radiator and the fourth radiator form a symmetrical configuration.

10. The antenna system of claim 9, wherein:
the second terminal of the primary winding of the first transformer is coupled to the first transceiver; and
the second terminal of the primary winding of the second transformer is coupled to the second transceiver.

11. The antenna system of claim 9, further comprising:
a third transceiver coupled to the second terminal of the primary winding of the first transformer; and
a fourth transceiver coupled to the second terminal of the primary winding of the second transformer;
a fifth switch coupled between the first terminal of the primary winding of the first transformer and the ground;
a sixth switch coupled between the second terminal of the primary winding of the first transformer and the ground;
a seventh switch coupled between the first terminal of the primary winding of the second transformer and the ground; and
an eighth switch coupled between the second terminal of the primary winding of the second transformer and the ground;
wherein the first transceiver and the third transceiver operate on different frequency bands, and the second transceiver and the fourth transceiver operate on different frequency bands.

12. The antenna system of claim 9, further comprising:
a first impedance tuner coupled between the first terminal of the secondary winding of the first transformer and the second radiator;
a second impedance tuner coupled between the second terminal of the secondary winding of the first transformer and the fourth radiator;
a third impedance tuner coupled between the first terminal of the secondary winding of the second transformer and the first radiator; and
a fourth impedance tuner coupled between the second terminal of the secondary winding of the second transformer and the third radiator.

13. An antenna system comprising:
a first transformer, comprising:
a primary winding, comprising a first terminal and a second terminal;
a secondary winding, comprising a first terminal and a second terminal; and
a tertiary winding, comprising a first terminal and a second terminal;
a first transmitter coupled to the first terminal of the primary winding of the first transformer;
a first receiver coupled to the first terminal of the secondary winding of the first transformer;
a first switch coupled between the first terminal of the tertiary winding of the first transformer and a ground;
a second switch coupled between the second terminal of the tertiary winding of the first transformer and the ground;
a fifth switch coupled between the first terminal and the second terminal of the primary winding of the first transformer;
a sixth switch coupled between the first terminal and the second terminal of the secondary winding of the first transformer; and
an antenna coupled to the first terminal and the second terminal of the tertiary winding of the first transformer;
wherein the antenna is a differential antenna.

14. The antenna system of claim 13, further comprising:
a second transformer, comprising:
a primary winding, comprising a first terminal and a second terminal; and
a secondary winding, comprising a first terminal and a second terminal; and
a tertiary winding, comprising a first terminal and a second terminal;
a second transmitter coupled to the first terminal of the primary winding of the second transformer;
a second receiver coupled to the first terminal of the secondary winding of the second transformer;
a third switch coupled between the first terminal of the tertiary winding of the second transformer and the ground;
a fourth switch coupled between the second terminal of the tertiary winding of the second transformer and the ground;
a seventh switch coupled between the first terminal and the second terminal of the primary winding of the second transformer;
an eighth switch coupled between the first terminal and the second terminal of the secondary winding of the second transformer; and
wherein the antenna is further coupled to the first terminal and the second terminal of the tertiary winding of the second transformer.

15. The antenna system of claim 14, further comprising:
a first capacitor coupled between the first terminal and the second terminal of the primary winding of the first transformer;
a second capacitor coupled between the first terminal and the second terminal of the secondary winding of the first transformer;
a third capacitor coupled between the first terminal and the second terminal of the tertiary winding of the first transformer;
a fourth capacitor coupled between the first terminal and the second terminal of the primary winding of the second transformer;
a fifth capacitor coupled between the first terminal and the second terminal of the secondary winding of the second transformer; and
a sixth capacitor coupled between the first terminal and the second terminal of the tertiary winding of the second transformer.

16. The antenna system of claim 14, wherein:
the second terminal of the primary winding of the first transformer is coupled to the first transmitter;
the second terminal of the secondary winding of the first transformer is coupled to the ground;
the second terminal of the primary winding of the second transformer is coupled to the second transmitter; and
the second terminal of the secondary winding of the second transformer is coupled to the ground.

17. The antenna system of claim 14, wherein:
the second terminal of the primary winding of the first transformer is coupled to the first transmitter;
the second terminal of the secondary winding of the first transformer is coupled to the first receiver;
the second terminal of the primary winding of the second transformer is coupled to the second transmitter; and
the second terminal of the secondary winding of the second transformer is coupled to the second receiver.

18. The antenna system of claim 14, wherein:
the antenna comprises a first radiator, a second radiator, a third radiator and a fourth radiator;
the first radiator, the second radiator, the third radiator and the fourth radiator form a symmetrical configuration;
the first terminal of the tertiary winding of the first transformer is coupled to the second radiator;
the second terminal of the tertiary winding of the first transformer is coupled to the fourth radiator;
the first terminal of the tertiary winding of the second transformer is coupled to the first radiator; and
the second terminal of the tertiary winding of the second transformer is coupled to the third radiator.

19. An antenna system comprising:
a first transformer, comprising:
a primary winding, comprising a first terminal and a second terminal;
a secondary winding, comprising a first terminal and a second terminal; and
a tertiary winding, comprising a first terminal and a second terminal;
a first transceiver coupled to the first terminal of the primary winding of the first transformer;
a second transceiver coupled to the first terminal of the secondary winding of the first transformer;
a first switch coupled between the first terminal of the tertiary winding of the first transformer and a ground;
a second switch coupled between the second terminal of the tertiary winding of the first transformer and the ground;
a second transformer, comprising:
a primary winding, comprising a first terminal and a second terminal;
a secondary winding, comprising a first terminal and a second terminal; and
a tertiary winding, comprising a first terminal and a second terminal;
a third transceiver coupled to the first terminal of the primary winding of the second transformer;
a fourth transceiver coupled to the first terminal of the secondary winding of the second transformer;
a third switch coupled between the first terminal of the tertiary winding of the second transformer and the ground; and
an antenna coupled to the first terminal and the second terminal of the tertiary winding of the first transformer, and to the first terminal and the second terminal of the tertiary winding of the second transformer;
wherein:
the antenna is a differential antenna;
the first transceiver and the second transceiver operate on different frequency bands; and
the third transceiver and the fourth transceiver operate on different frequency bands.

20. The antenna system of claim 19, wherein:
the second terminal of the primary winding of the first transformer is coupled to the first transceiver;
the second terminal of the secondary winding of the first transformer is coupled to the second transceiver;
the second terminal of the primary winding of the second transformer is coupled to the third transceiver; and
the second terminal of the secondary winding of the second transformer is coupled to the fourth transceiver.

21. The antenna system of claim 19, wherein:
the antenna comprises a first radiator, a second radiator, a third radiator and a fourth radiator;
the first radiator, the second radiator, the third radiator and the fourth radiator form a symmetrical configuration;
the first terminal of the tertiary winding of the first transformer is coupled to the second radiator;
the second terminal of the tertiary winding of the first transformer is coupled to the fourth radiator;
the first terminal of the tertiary winding of the second transformer is coupled to the first radiator; and
the second terminal of the tertiary winding of the second transformer is coupled to the third radiator.
